(19) United States
(12) Patent Application Publication
(10) Pub. No.: US 2004/0176065 A1
(43) Pub. Date: Sep. 9, 2004

(54) Low power operation in a personal area network communication system

(76) Inventor: Bo Liu, Champaign, IL (US)

Correspondence Address: MOTOROLA, INC., 1303 EAST ALGONQUIN ROAD, IL01/3RD, SCHAUMBURG, IL, 60196

(21) Appl. No.: 10/369,851

(22) Filed: Feb. 20, 2003

(51) Int. Cl. H04B 1/38

(52) U.S. Cl. 455/343.1; 455/73; 455/552.1

(57) ABSTRACT

A method for low power operation in a personal area network communication system including a master device operable to host the personal area network and a slave device operable on the personal area network. A first step of the method includes defining a low power operational mode of an accessory device wherein the accessory device is substantially disconnected from the personal area network. A next step includes providing a user-actuated mechanism of the accessory device to direct the accessory device to enter the low power operational mode. A next step includes activating the mechanism of the accessory device to direct the entry of the accessory device into the low power operational mode.

### FIELD OF THE INVENTION

The present invention generally relates to reducing power consumption in communication devices. More particularly, the present invention relates to power management Bluetooth™ devices.

### BACKGROUND OF THE INVENTION

Many communication devices and accessories operate on battery power. The telecommunication devices in use today are almost all portable devices utilizing batteries that need periodic recharging. The size of the battery and the power efficiency of the communication device determine the amount of communication time available to a user. As a convenience to a user, it has always been desirable to extend the life of the battery to provide longer communication times. However, even with the present devices, communications are occasionally interrupted, requiring the recharging of the battery or replacement with a freshly recharged battery.

Moreover, new phone features and standards are dramatically elevating device functions, which increase processing power requirements. Such new features and functions local/personal area connectivity and wireless multimedia, for example. These requirements also increase processing speed, which is known to increase current drain. Personal area networks such as Bluetooth™ that provide personal connectivity services to a computer or peripherals, multimedia cards, and multiple high processing functions all require an increased level of processor operational speed, hardware accelerators, more complicated hardware and software, and larger and more complicated instruction sets.

As a result, the operational frequency of the device processor has increased and the number of transistors on the IC sets has increased to support these new functions and interfaces. Modern silicon technology has been improving, but has not kept pace with the functional revolution in wireless technology. Consequently, the power demands on wireless devices have been constantly increasing. Therefore, it has been desirable to further extend the battery life on such devices.

At the same time, there are limiting factors in the devices themselves. New wireless devices must be as small or smaller than the devices they are replacing. Therefore, batteries must be smaller. In addition, the amount of power dissipation is limited by the smaller package, existing silicon technology, and the temperature limits of components in the device. Further, the battery technology is not able to provide the necessary current for a sufficient time in some of the more desirable or longer communication user modes. For example, local connectivity to a computer and multimedia functions would place a high current drain on a battery.

There are several existing power management techniques to reduce power consumption of wireless circuits and processors. These techniques include (U.S. patent class 713/320) lowering voltage, frequency modulation, lowering frequency, gating clocks and/or transmitter/receiver, shutdown components in the phone that are not being used at the time (standby/sleep mode), etc. However, these techniques may not all be applicable to local/personal connectivity standards, such as those required by Bluetooth™.

Accordingly, there is a need for a low power operational mode for current reduction and extension of a battery lifetime in a wireless communication device such as a local/personal area network accessory. There is a further need to provide user input and options as to the operability of the power modes of the device. It would also be of benefit to provide these advantages without additional hardware, which would increase the cost of the communication device.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 is a simplified schematic diagram of a communication system, in accordance with the present invention;

FIG. 2 is a perspective view of an accessory device, in accordance with the present invention; and

FIG. 3 is a flow chart for a method of low-power operation, in accordance with the present invention.

### DETAILED DESCRIPTION OF A PREFERRED EMBODIMENT

The present invention reduces the current drain in a communication device by providing a low power operational mode that is controlled by a user of the device. The present invention finds particular utility in a remote wireless accessory device connected in a local/personal area network, such as IEEE 802.11 or Bluetooth™, for example. The present invention provides for user input to direct the functionality of the remote accessory device instead of a radiotelephone/handset device of the local/personal area network controlling the remote device. Specifically, a user of a remote device can disconnect the device from the local/personal area network and place it in a standby mode. This reduces the total current drain and extends the battery life of the device by limiting the amount of information processed, transmitted and received by the device, and in particular, by wireless connectivity, which usually takes the most power consumption. This is accomplished in a radiotelephone without additional hardware, which would increase the cost of the communication device.

In general, the personal area network is a wireless connection of two (or more) devices via the Bluetooth standard. Bluetooth is a low cost, low power, short range radio technology, originally developed as a cable replacement to connect devices such as radiotelephone handsets, headsets, and portable computers. The Bluetooth system uses frequency-hopping spread spectrum (FHSS) radio technology which operates within seventy-nine channels in the 2.400 GHz to 2.4835 GHz frequency range. The wireless connection between two or more Bluetooth devices changes frequencies at fixed time intervals, hopping around the channels in a “pseudo-random” sequence at a frequency of 1600 times per second. The master device in the Bluetooth master-slave connection determines both the timing of the hopping and the selection and sequence of channels used.

To remotely establish a Bluetooth connection between an accessory device, such as a headset, and a radiotelephone from the headset, the headset needs to send a LMP (Link Manager Protocol) host connection request over to the radiotelephone. After the radiotelephone accepts the connection and both devices finish setting-up an ACL(Asynchronous Connection-Less) link, the headset initiates a service discovery process through a Service Discovery Protocol for the available services and then sets up an RF communication (RFCOMM) connection for data/control packet transmission.

After the Bluetooth connection is established, both of the units (the radiotelephone and the headset) are in a “connected” state. In the connected state, Bluetooth transceivers in both devices alternatively transmit and receive data and control packets between each other. In addition, the master device needs to support regular transmissions to keep any slave devices synchronized to the channel. In the meantime, the slave devices need to listen for these packets. This is a power consuming process. At the present time, the Bluetooth link can only be disconnected through Bluetooth protocols by the radiotelephone/handset device (except for the obvious case of turning off the accessory/headset device).

The present invention provides for remote disconnection of a Bluetooth link from the accessory/headset device using Bluetooth protocols. Specifically, the present invention allows the accessory/headset device to command a standby state for the Bluetooth link for both the master and slave devices. To remotely disconnect the Bluetooth link between a headset and a phone from the headset, the headset sends an RFCOMM disconnection request and a LMP detach command over to the radiotelephone to end the link. After the link is disconnected, both the Bluetooth units (the radiotelephone and the headset) are in a “standby” state. In the standby state, both the master and the slave devices are in a low-power mode. The transceivers of the devices are then periodically turned on to detect any pages for the other device, whereupon the device will reawaken, acquire synchronization and establish communication as described above.

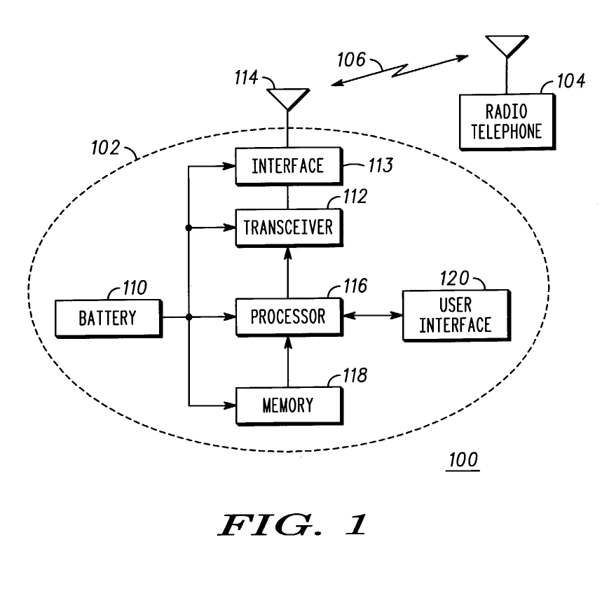

Referring now to FIG. 1, a local/personal area network communication system having a low power operational mode is shown, in accordance with the present invention. The local/personal area network communication system 100 includes a remote or slave device or accessory 102 with components powered by a battery 110. The battery has a power capacity and provides power to components within the accessory device. Preferably, the battery is rechargeable. The accessory 102 is configured to provide local communication interconnectivity to a device 104, such as a radiotelephone handset. This connection can be in any standard local communication system, such as IEEE 802.11 or personal communication system, such as Bluetooth™, for example. Both the radiotelephone handset 104 and accessory headset 102 can be configured to host the local connectivity, such as a personal area network (PAN) 106, as a master device.

The wireless accessory 102 includes a transceiver 112 therein coupled to one or more antennas 114. The transceiver is adapted to input and output information. A connectivity interface 113 is coupled to the transceiver. The interface 113 transceives information between the accessory device and the personal area network. The radiotelephone is controlled by a processor 116 that is generally coupled to all the components of the accessory 102, and particularly to the transceiver and interface. The processor 116 can be a microprocessor, microcontroller, DSP, combination of both, or other similar control circuit. The processor 116 obtains its instructions from a memory 118. The memory can be a static, dynamic, flash or erasable memory of a ROM or RAM configuration. Along with the standard uses for memory, the memory 118 can also contain many different applications to provide various functions of the accessory. Optionally, the processor can also download application from the PAN 106 that can be stored in memory 118. A user interface 120 is coupled to the processor to provide and receive user information and control. The user interface can include a display, several buttons or a keypad, a microphone and a speaker or earpiece. It should be recognized that there are many other devices necessary in the operation of the accessory device that are not shown, to avoid confusion.

The antenna 114 receives signals from the radiotelephone device 104 through a personal connection 106 in the vicinity. Received signals are converted to electrical signals by the antenna 114 and provided to the transceiver 112 to provide conversion to baseband or data signals. The transceiver 112 includes an amplifier and other circuitry, such as RF circuits and demodulation circuitry, as is known in the art. The baseband or data signals are provided to the other circuits (not shown) in the accessory 102, which converts them to streams of digital data for further processing. Similarly, the accessory 102 provides data or baseband signals through modulation circuitry (not shown) in the transceiver 112, which sends electrical signals to the antenna 114 for transmission to the master device on the PAN 106. Typically, a transmitter power amplifier consumes the most power in the accessory 102.

The processor 116 controls the functions of the accessory 102. The processor 116 operates in response to stored programs of instructions, and can load such stored programs as needed to provide a particular function of the accessory 102. Optionally, to save some processing in the accessory, information can be downloaded from the accessory 102 to the device 104 for more complex processing and the results conveyed back to the accessory 102. The processor is responsible to direct communication on the local area network as previously described, and is adapted to operate in conjunction with the low power and full power operational modes of the accessory device, in accordance with the present invention.

The user interface 120 includes a user-actuated mechanism coupled to the processor, wherein upon actuation, the mechanism can direct the processor to enter either of the low power operational mode and full power operational mode, wherein the processor disconnects and connects, respectively, the connectivity interface 113 and can power down the transceiver 112. Preferably, the processor can communicate the low power operational mode of the accessory/headset device to the phone/handset device over the personal area network. In this way, the phone/handset device can also power down its components associated with sustaining the personal area network as desired. More preferably, the disconnection of the personal area network link precipitates a low-power standby mode for the accessory/headset device as optionally the phone/handset device. In this low-power, standby operational mode, a predetermined over-the-air protocol operates wherein the processor can periodically reconnect the connectivity interface to monitor the local/personal area network for communications directed (page) at the accessory device. Upon detection of a paging condition, the processor reconnects the connectivity interface and turns on the transceiver such that the accessory device is in a full-power operational mode. Low-power operation minimizes the power drain on the battery for monitoring of the over-the-air protocol.

The over-the-air protocol can provide many different techniques to reduce current drain on the battery. The main techniques for power saving can be: a) to limit the amount of information processed, transmitted and received by the phone, especially by wireless connectivity, which usually takes the most power consumption, b) to use lower data rate transmission protocols requiring lower amounts of information and processor computations, c) to change to a connectivity interface requiring lower power consumption, and d) to place the devices into a sleep mode and periodically wake up to look for pages, for example.

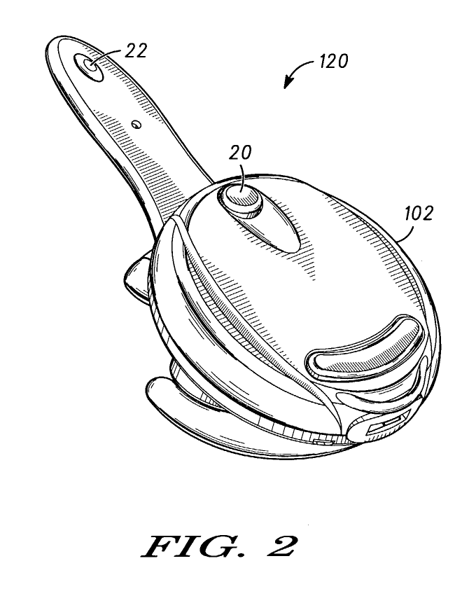

Referring to FIG. 2, in one embodiment, the user-actuated mechanism of the user interface 120 of the accessory device 102 is a button 20. The button may be specifically for directing the processor to initiate the connection or disconnection of the link. Alternatively, an existing button can be used having a specialized functionality wherein a predetermined key press sequence, such as a single depression of the button initiates connection (full power operation) or a quick double depression of the button initiates disconnection (low power operation) of the link. Optionally, the user-actuated mechanism can be speech recognition through a microphone 22 and the processor, wherein voice actuation can be the mechanism to direct the slave device to enter the low power operational mode. In particular, the voice commands “CONNECT LINK” or “DISCONNECT LINK” can be used, as well as several other viable alternatives within the scope of the present invention. Alternatively, the processor can initiate its own controlled disconnect of the local/personal area network before exhaustion of the battery.

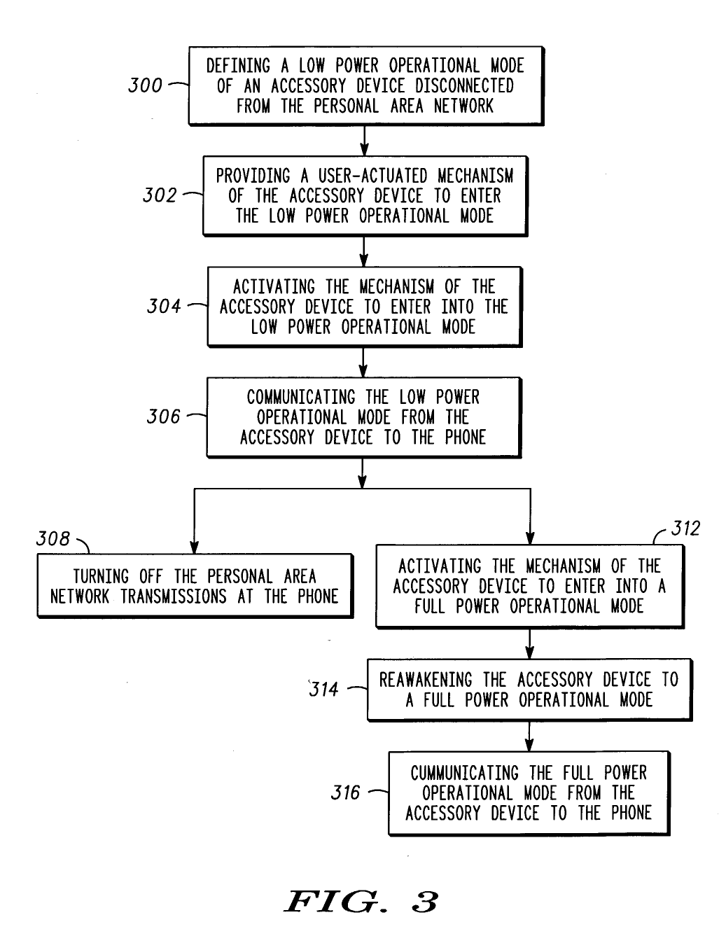

FIG. 3 shows a method for low power operation in a local/personal area network communication system including a master device operable to host the local area network and a slave device operable on the local area network. For a Bluetooth personal area network, both audio gateways, such as a radiotelephone or an accessory such as a headset, can be a master or a slave, depending on which device initiates the PAN link. The method includes a first step 300 of defining a low power operational mode of the accessory/headset device wherein the accessory/headset device is substantially disconnected from the personal area network. This low-power mode can include either a full disconnection of the PAN link or can entail a standby mode with a predetermined over-the-air protocol wherein a connection is periodically re-established to detect if any pages (communications directed at the accessory device) can be detected.

A next step 302 includes providing a user-actuated mechanism of the accessory/headset device to direct the accessory/headset device to enter the low power operational mode. This mechanism can include a new button, an existing button with added functionality actuated by a predetermined key press sequence, a voice activated command, and the like, as previously explained.

A next step 304 includes activating the mechanism of the slave device to direct the entry of the accessory/headset device into the low power operational mode. The activation can be by a user of the accessory device or by a processor of the accessory device detecting a low battery capacity. A next step 306 includes communicating the low power operational mode from the accessory/headset device to the radiotelephone device over the personal area network.

In a preferred embodiment, the method includes further steps 308-312 that provide action on the part of the radiotelephone device. In this embodiment, a next step includes turning off 308 the personal area network transmissions at the radiotelephone device. In an alternative embodiment, the next steps include activating 312 the mechanism of the accessory/headset device to direct the entry of the accessory/headset device into a full power operational mode, reawakening 314 the accessory/headset device to a full power operational mode and communicating 316 the full power operational mode from the accessory/headset device to the radiotelephone device over the personal are network.

As can be seen from the foregoing, the present invention provides a method and apparatus for low power operation in a local/personal area network communication system, and in particular in an accessory device of the LAN/PAN. Advantageously, the present invention gives the user of an accessory device to option of disconnecting the LAN/PAN link from the accessory device. It also reduces the total current drain and extends the battery life of an accessory device by provide a low-power, standby operational mode of the accessory device.

While a particular embodiment of the present invention has been shown and described, modifications may be made. It is therefore intended in the appended claims to cover all such changes and modifications which fall within the broad scope of the invention.

What is claimed is:

1. A method for low power operation in a personal area network communication system including a master device operable to host the personal area network and a slave device operable on the personal area network, the method comprising the steps of:
defining a low power operational mode of an accessory device wherein the accessory device is disconnected from the personal area network;
providing a user-actuated mechanism of the accessory device to direct the accessory device to enter the low power operational mode; and
activating the mechanism of the accessory device to direct the entry of the accessory device into the low power operational mode.

2. The method of claim 1, wherein the providing step includes a voice actuated mechanism of the accessory device to direct the accessory device to enter the low power operational mode.

3. The method of claim 1, wherein the mechanism of the providing step includes a button on the accessory device.

4. The method of claim 3, wherein the activating step includes executing a predetermined key press sequence of the button to enter the low power operational mode.

5. The method of claim 1, further comprising the steps of:
communicating the low power operational mode from the accessory device to a radiotelephone over the personal are network; and
turning off the personal area network transmissions at the radiotelephone.

6. The method of claim 1, further comprising the steps of:
communicating the low power operational mode from the accessory device to the radiotelephone over the personal area network;
activating the mechanism of the accessory device to direct the entry of the accessory device into a full power operational mode;
reawakening the accessory device to a full power operational mode; and
communicating the full power operational mode from the accessory device to the radiotelephone over the personal area network.

7. The method of claim 1, wherein the personal area network is a Bluetooth communication network.

8. A method for low power operation in a personal area network communication system including a master device operable to host the personal area network and a slave device operable on the personal area network, the method comprising the steps of:
defining a low power operational mode of an accessory device wherein the accessory device is substantially disconnected from the personal area network;
providing a user-actuated mechanism of the accessory device to direct the accessory device to enter the low power operational mode;
activating the mechanism of the accessory device to direct the entry of the accessory device into the low power operational mode; and
communicating the low power operational mode from the accessory device to the radiotelephone over the personal area network.

9. The method of claim 8, wherein the providing step includes a voice actuated mechanism of the accessory device to direct the accessory device to enter the low power operational mode.

10. The method of claim 8, wherein the mechanism of the providing step includes a button on the accessory device.

11. The method of claim 10, wherein the activating step includes executing a predetermined key press sequence of the button to enter the low power operational mode.

12. The method of claim 8, further comprising the step of turning off the personal area network transmissions at the radiotelephone.

13. The method of claim 8, wherein the defining step includes defining a predetermined over-the-air protocol wherein the accessory device can periodically monitor the personal area network for communications directed at the accessory device using a minimum power capacity for monitoring of the over-the-air protocol.

14. The method of claim 13, further comprising the step of reawakening the accessory device to a full power operational mode when a communication is monitored that is directed at the accessory device.

15. The method of claim 13, wherein the predetermined over-the-air protocol has a lower processor computations than are used for normal communications on the personal area network.

16. A portable personal area network accessory device with a low power operational mode, the accessory device comprising:
a battery with a power capacity, the battery providing power to components within the accessory device;
a transceiver included within the accessory device, the transceiver adapted to input and output information;
a connectivity interface coupled to the transceiver, the interface for transceiving information between the accessory device and the personal area network;
a processor coupled to the transceiver and interface, the processor adapted to operate in conjunction with the low power and full power operational modes of the accessory device; and
a user-actuated mechanism coupled to the processor, wherein upon actuation, the mechanism can direct the processor to enter either of the low power operational mode and full power operational mode, wherein the processor disconnects and connects, respectively, the connectivity interface.

17. The accessory device of claim 16, wherein the processor communicates the low power operational mode of the accessory device to a radiotelephone over the personal area network initiating a low power operating mode in the radiotelephone.

18. The accessory device of claim 16, further comprising a predetermined over-the-air protocol operable during low power operation, wherein the processor can periodically reconnect the connectivity interface to monitor the personal area network for communications directed at the accessory device using a minimum power capacity for monitoring of the over-the-air protocol.

19. The accessory device of claim 18, wherein during a low power operational mode the processor uses lower processor computations than are used for normal communications on the personal area network.

20. The accessory device of claim 18, wherein the processor reconnects the connectivity interface to a full power operational mode when a communication is monitored that is directed at the accessory device.
